(19) United States
(12) Patent Application Publication
(10) Pub. No.: US 2006/0237139 A1
(43) Pub. Date: Oct. 26, 2006

(54) Vacuum ultraviolt ray bonding apparatus

(76) Inventor: Hideo Onuki, Ibaraki (JP)

Correspondence Address: MORGAN LEWIS & BOCKIUS LLP, 1111 PENNSYLVANIA AVENUE NW, WASHINGTON, DC, 20004, US

(21) Appl. No.: 10/548,300

(22) PCT Filed: Feb. 10, 2004
(86) PCT No.: PCT/JP04/01371

§ 371 Date: Sep. 6, 2005

(30) Foreign Application Priority Data
Mar. 6, 2003 (JP) 2003-060570

(51) Int. Cl. B32B 37/00

(52) U.S. Cl. 156/379.6; 156/382

(57) ABSTRACT

A VUV-ray adhering apparatus for applying material of alkoxide to adhering faces of adhered substances and irradiating VUV-ray to the adhering faces to adhere is provided, the apparatus including: a VUV-ray light source portion having a light source for generating the VUV-ray, an irradiating chamber for irradiating the VUV-ray to two of the adhered substances which are transparent for the VUV-ray, and an exhausting apparatus for exhausting atmosphere in the VUV-ray light source portion and the irradiating chamber forcibly to outside. Further, the VUV-ray light source portion and the irradiating chamber are vacuumed or the VUV-ray light source portion and the irradiating chamber are filled with nitrogen gas or rare gas. Further, a partition window of a substance transparent for the VUV-ray is provided between the VUV-ray light source portion and the irradiating chamber. Therefore, a highly efficient, economical and most preferable VUV-ray adhering apparatus with ultraviolet ray having a short wavelength in a range of 200 nm through 50 nm can be provided.

### TECHNICAL FIELD

The present invention relates to a vacuum ultraviolet (hereinafter referred as VUV)-ray adhering apparatus capable of adhering two substances at room temperature by irradiating VUV-ray to material alkoxide applied to adhering faces of the two substances at least one of which is transparent for VUV-ray (refer to ultraviolet ray having a short wavelength in a range of 200 nm through 50 nm in the specification).

### RELATED ART

Ultraviolet ray used for curing and adhering by ultraviolet ray of a background art is limited to ultraviolet ray having a wavelength longer than 350 nm. Therefore, the adhering is carried out by an adhering apparatus having a light source for generating the ultraviolet ray having a wavelength longer than 350 nm.

Meanwhile, very recently, the inventors have invented a method of adhering two substances at least one of which is transparent for ultraviolet ray having a wavelength shorter than 350 nm by irradiating the ultraviolet ray having the wavelength shorter than 350 nm to an adhering portion by applying an adhering agent by alkoxide (refer to JP-A-Hei10-282339).

The above-described invention described in JP-A-Hei10-282339 simple irradiation of xenon excimer lamp light (having spectrum of 155 nm through 200 nm) to the adhering portion, but, neither clarifies nor resolves a problem for realizing highly efficient and economically most preferable adhering by ultraviolet ray having a wavelength shorter than 200 nm.

Further, with regard to the above-described invention described in JP-A-Hei10-282339, the following problems are considered in order to realize a highly efficient and economically most preferable VUV-ray adhering apparatus having a wavelength shorter than 200 nm.

(1) The VUV-ray is strongly absorbed by oxygen molecules in air. For example, almost all of VUV-ray having a wavelength of 185 nm is absorbed by an air layer in the thickness of about 20˜30 mm. Almost all of VUV-ray of 172 nm is absorbed by an air layer of about 5 mm thickness.

(2) The oxygen molecules which have absorbed VUV-ray are decomposed to generate harmful ozone. Therefore, normally, a light path of VUV-ray needs to be in vacuum as its name signifies. Further, absorption of VUV-ray by nitrogen gas and rare gas is started by a wavelength shorter than about 100 nm and therefore, nitrogen gas and rare gas are transparent gases preferable for a wavelength region between 100 nm and 200 nm.

(3) Generally, any substances except portions thereof strongly absorb VUV-ray in a VUV-ray region and reflectances of VUV-ray at surfaces of substances are extremely low.

(4) Further, when taking a look at a light source side, kinds of VUV-ray light sources having large light emitting intensities are extremely limited.

In this way, a VUV-ray region has a number of difficulties which are not present in a ultraviolet ray region having a wavelength longer than 200 nm.

It is an object of the invention to provide a highly efficient and economically most preferable VUV-ray adhering apparatus which has not been existed in such a technically difficult VUV-ray region.

### DISCLOSURE OF THE INVENTION

(1) According to the invention, there is provided with a VUV-ray adhering apparatus for applying material of alkoxide to adhering faces of adhered substances and irradiating VUV-ray to the adhering faces to adhere, the apparatus including: a VUV-ray light source portion having a light source for generating the VUV-ray, an irradiating chamber for irradiating the VUV-ray to two of the adhered substances at least one of which is transparent for the VUV-ray, and an exhausting apparatus for exhausting atmosphere in the VUV-ray light source portion and the irradiating chamber forcibly to outside.

According to the constitution, ozone generated in irradiating the VUV-ray is exhausted and therefore, in a room installed with the VUV-ray adhering apparatus, during a time period of irradiating the VUV-ray, offensive smell of ozone is not felt at all.

(2) Further, according to the invention, there is provided with the VUV-ray adhering apparatus according to the above-described constitution (1), wherein the VUV-ray light source portion and the irradiating chamber are vacuumed.

According to the constitution, ozone is not generated at all and the loss of light intensity on an optical path of the VUV-ray is drastically reduced.

(3) Further, according to the invention, there is provided with the VUV-ray adhering apparatus according to the above-described constitution (1), wherein the VUV-ray light source portion and the irradiating chamber are filled with nitrogen gas or rare gas.

According to the constitution, nitrogen gas or rare gas is made to flow to the VUV-ray adhering apparatus in steady state, inside of the apparatus can be brought in an atmosphere of the gas and therefore, generation of ozone is remarkably reduced, which is preferable for the health of the human being. Further, also the light loss on the optical path of the VUV-ray is remarkably reduced.

(4) Further, according to the invention, there is provide is with the VUV-ray adhering apparatus according to the above-described constitution (1), further including: a partition window of a substance transparent for the VUV-ray provided between the VUV-ray light source portion and the irradiating chamber.

According to the constitution, when an interval between the VUV-ray light source portion and the irradiating chamber is partitioned by the window of synthesized quartz glass transparent up to short wavelength of 160 nm, ozone of the VUV-ray light source portion or the irradiating chamber, or ozone of both thereof generated in irradiating the VUV-ray is forcibly exhausted, offensive smell of ozone is not felt at all in the room during the time period of irradiating the VUV-ray.

(5) Further, according to the invention, there is provided with the VUV-ray adhering apparatus according to the above-described constitution (4), further including: an exhausting apparatus for forcibly exhausting air in the VUV-ray light source portion or the irradiating chamber.

(6) Further, according to the invention, there is provided with the VUV-ray adhering apparatus according to the above-described constitution (4) or (5), wherein the VUV-ray light source portion or the irradiating chamber is filled with nitrogen gas or rare gas.

(7) Further, according to the invention, there is provided with the VUV-ray adhering apparatus according to the above-described constitution (4) or (5), wherein the VUV-ray light source portion or the irradiating chamber is vacuumed.

(8) Further, according to the invention, there is provided with the VUV-ray adhering apparatus according to the above-described constitution (1) through (7), wherein a xenon excimer lamp or a low pressure mercury lamp is used as a light source of the VUV-ray light source portion.

(9) Further, according to the invention, there is provided with the VUV-ray adhering apparatus according to the above-described constitution (1) through (8), wherein the light source of the VUV-ray light source portion is formed spirally.

According to the constitution, the light source can be arranged to concentrate on the adhering face of the adhered substance and therefore, uniform and efficient irradiation is achieved.

(10) Further, according to the invention, there is provided with the VUV-ray adhering apparatus according to the above-described constitution (1) through (9), further including: a light converging mirror provided at the light source of the VUV-ray light source portion.

According to the constitution, the VUV-ray can efficiently be converged to the adhered substance of the irradiating chamber.

(11) Further, according to the invention, there is provided with the VUV-ray adhering apparatus according to the above-described constitution (1) through (10), wherein an inner wall face of the VUV-ray light source portion or the irradiating chamber is made of aluminum.

According to the constitution, an intensity of the VUV-ray in the VUV-ray adhering apparatus can be increased.

(12) Further, according to the invention, there is provided with the VUV-ray adhering apparatus according to the above-described constitution (1) through (11), further including: a pressing apparatus for pressing adhering faces of two of the adhered substances.

According to the constitution, adherence of a uniform adhering face and high strength can be achieved.

(13) Further, according to the invention, there is provided with the VUV-ray adhering apparatus according to the above-described constitution (1) through (12), wherein a supporting member for supporting the adhered substance is made to be rotatable.

According to the constitution, the VUV-ray can be irradiated while rotating the adhered substance and therefore, uniform and efficient irradiation can be achieved.

### BRIEF DESCRIPTION OF THE DRAWINGS

FIG. 1 is a front view showing an outline of a VUV-ray adhering apparatus according to Embodiment 1 of the invention.

FIG. 2 is a view showing a state of adhering overlapping faces of members in a flat plate shape according to an example of a mode of adhering an adhered substance.

FIG. 3 is a view showing a state of bonding end faces of members in a flat plate shape according to an example of a mode of adhering an adhered substance.

FIG. 4 is a view showing a state of adhering end faces of cylindrical members according to an example of a mode of adhering an adhered substance.

FIG. 5 is a front view showing an outline of a VUV-ray adhering apparatus according to Embodiment 2 of the invention.

FIG. 6 is a perspective view showing an outline of an essential portion of a VUV-ray adhering apparatus according to Embodiment 3 of the invention.

FIG. 7 is a perspective view showing an outline of an essential portion of a VUV-ray adhering apparatus according to Embodiment 4 of the invention.

FIG. 8 is a front view showing an outline of a VUV-ray adhering apparatus according to Example 1 of the invention.

FIG. 9 is a front view showing an outline of a VUV-ray adhering apparatus according to Example 2 of the invention.

FIG. 10 is a front view showing an outline of a VUV-ray adhering apparatus according to Example 3 of the invention.

### BEST MODE FOR CARRYING OUT THE INVENTION

In order to describe the invention further in details, an explanation will be given of the invention in reference to the attached drawings.

### Embodiment 1

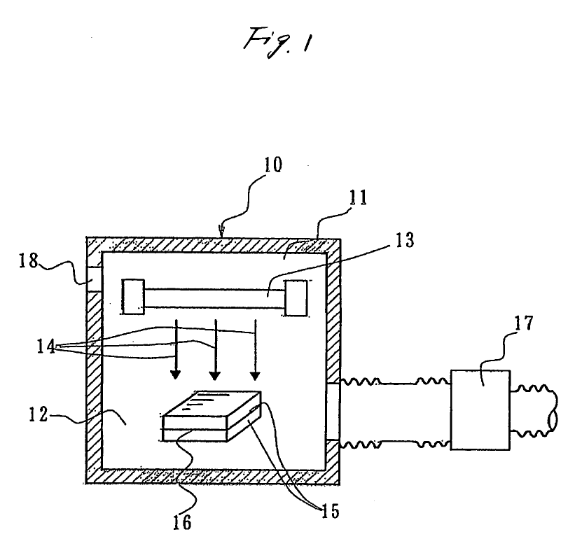

FIG. 1 shows Embodiment 1 and a VUV-ray adhering apparatus 10 is mainly constituted by a VUV-ray light source portion 11 and an irradiating chamber 12. The VUV-ray light source portion 11 is provided with a VUV-ray light source 13 for generating VUV-ray (ultraviolet ray in a wavelength region of 100 nm through 50 nm) 14. Light ray generated from the VUV-ray light source 13 having a wavelength region of 200 nm through 100 nm is preferable.

Further, in the irradiating chamber 12, adhered substances 15, 15 are placed in a state of being brought into contact with each other at an adhered face 16. The adhered substances 15, 15 are constituted by dropping tetramethoxysilane (TMOS; a composition of which is TMOS monomer 91.83%, TMOS oligomer 3.32%, water/methanol 4.84%: however, composition ratios of which do not need to be strictly as they are) as material of alkoxide on the adhered face 16 of one sheet of the adhered substance 15 at pertinent intervals, coating tetramethoxysilane uniformly on a face thereof by, for example, a spin coating method and overlapping other of the adhered substance on the adhered substance 15.

The VUV-ray adhering apparatus 10 is preferable for health when the VUV-ray adhering apparatus 10 is further provided with an exhausting apparatus 17 for exhausting harmful ozone generated by the VUV-ray 14 to out of the chamber and an outside air-introducing-port 18 in irradiating the VUV-ray 14. Further, when a material of an inner wall of the VUV-ray adhering apparatus 10 is constituted by aluminum having high reflectance, VUV-ray can effectively be utilized.

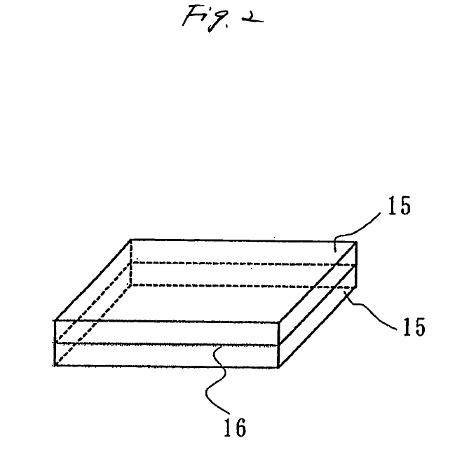

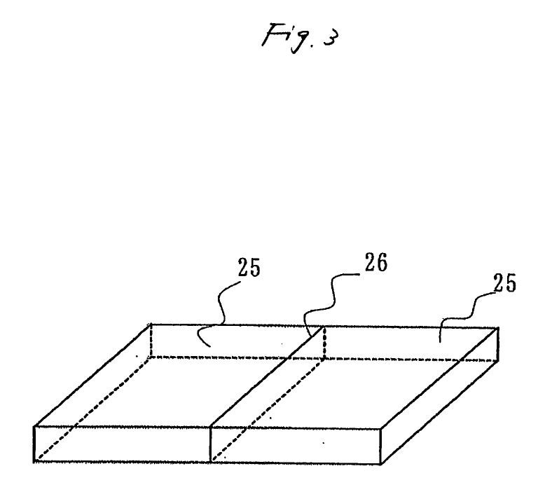

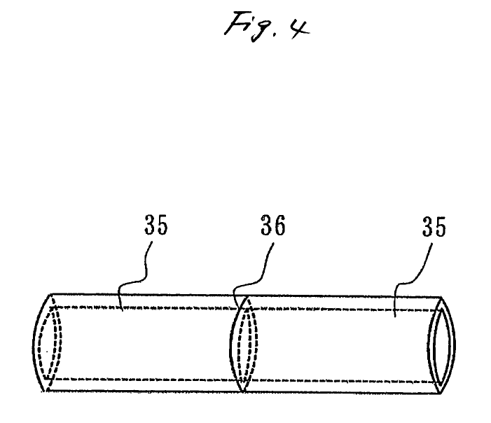

As basic modes of adhering the adhered substance, there are a type of overlapping flat plate shape members 15, 15 constituting the adhered substances as shown by FIG. 2 and adhering the flat plate shape members 15, 15 at the adhered face 16, a type of bonding end faces of flat plate shape members 25, 25 constituting the adhered substances as shown by FIG. 3 and adhering the flat plate shape members 25, 25 at an adhered face 26, and a type of bonding end faces of cylindrical members 35, 35 constituting adhered substances and adhering the cylindrical members 35, 35 at an adhered face 36 as shown by FIG. 4. Other than the adhering modes, there are conceivable various application types of intersecting two adhered substances by a certain angle to adhere and so on.

### Embodiment 2

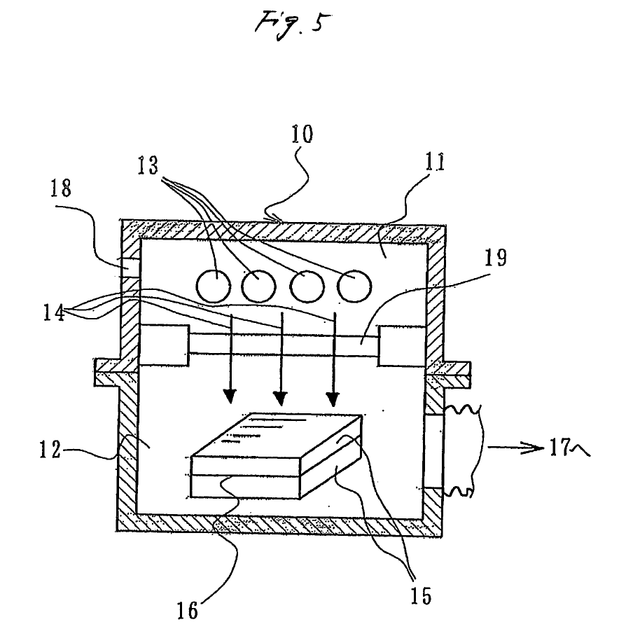

FIG. 5 shows Embodiment 2 and notations the same as those of Embodiment 1 designate the same members. According to Embodiment 2, there is constituted a structure of providing a partition wall 19 of glass transparent for VUV-ray in a wavelength region of 200 nm through 50 nm between the VUV-ray light source portion 11 and the irradiating chamber 12. It is preferable to provide the exhausting apparatus 17 for forcibly exhausting the atmosphere in the VUV-ray light source portion 11 or the irradiating chamber 12 for exhausting ozone. Further, the partition wall 19 is not needed when both of the VUV-ray light source portion 11 and the irradiating chamber 12 are provided with an apparatus for forcibly exhausting their atmospheres.

Further, it is preferable to bring the VUV-ray light source portion 11 or the irradiating chamber 12 in an atmosphere of nitrogen gas or rare gas. Further, in this case, the partition wall 19 is not needed when both of the VUV-ray light source portion 11 and the irradiating chamber 12 are brought in the atmosphere of nitrogen gas or rare gas.

Further, it is most preferable to bring the VUV-ray light source portion 11 or the irradiating chamber 12, or both thereof in vacuum. In this case, a cabinet of the VUV-ray adhering apparatus is constituted by a structure of withstanding the atmospheric pressure. Further, the partition window 19 is not needed when both of the VUV-ray light source portion 11 and the irradiating chamber 12 are brought in vacuum.

Further, when aluminum is used for the material of the inner wall of the VUV-ray adhering apparatus 10, it is further preferable.

### Embodiment 3

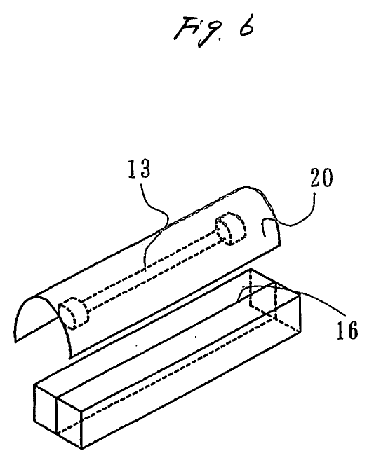

Embodiment 3 is provided with a light converging mirror 20 at a vicinity of the VUV-ray light source 13 for efficiently converging VUV-ray to the irradiating chamber 12 as shown by FIG. 6 in the VUV-ray light source portion of the VUV-ray adhering apparatus of Embodiment 1 or 2. Although there may be provided singles of the VUV-ray light source 13 and the light converging mirror 20 when the adhered face 16 of the adhered substance is one-dimensionally prolonged, when the adhered face 16 is provided with a two-dimensionally large area, it is preferable to use a necessary number of sets of the VUV-ray light sources 13 and the light converging mirrors 20.

### Embodiment 4

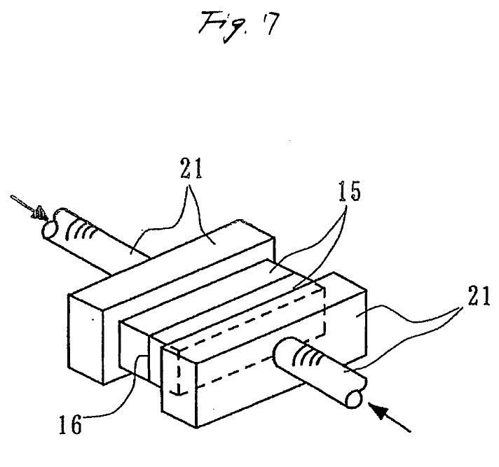

Embodiment 4 is provided with pressing apparatus 21 for pressing the two adhered substances 15, 15 from outer sides for narrowing a gap between the two adhered substances 15 at the adhered face 16 as shown by FIG. 7 in the irradiating portion 12 of the VUV-ray adhering apparatus of Embodiment 1 or 2. Depending on the adhered substance, the adhered substance having an excellent adhered state is provided by pressing the adhered face by the pressing member 21 in this way.

### EXAMPLES

### Example 1

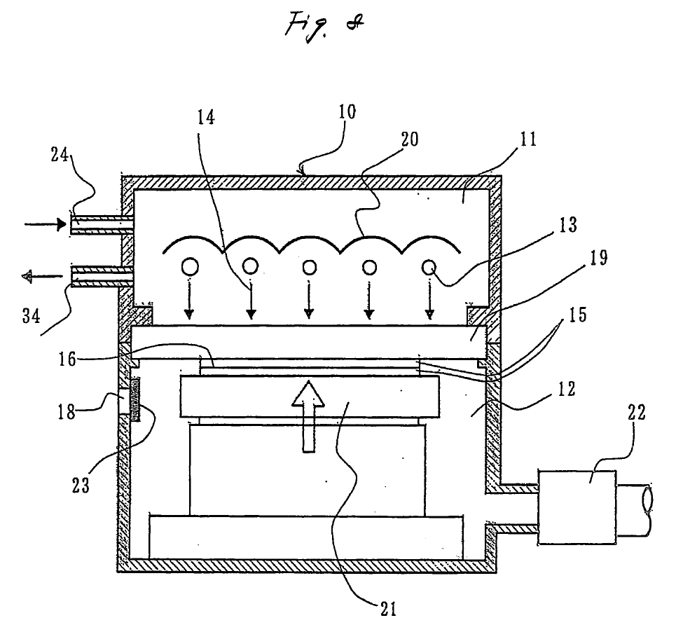

FIG. 8 shows Example 1, and in the VUV-ray adhering apparatus 10, two sheets of quartz glass 15, 15 of 100 mm×10 mm, thickness 6 mm constituting adhered substances are overlapped and adhered.

The VUV-ray adhering apparatus 10 is mainly constituted by the VUV-ray light source portion 11 containing a xenon excimer lamp 13 and the irradiating chamber 12 in which the adhered substance 15 is placed partitioned by a window of synthesized quartz glass 19 having an area of 150 cm×150 cm and a thickness of 10 mm.

The VUV-ray light source portion 11 is provided with 5 pieces of xenon excimer lamps 13 in a linear shape having a length of about 110 mm as irradiating light sources, and the VUV-ray 14 from the lamp 13 is made to be substantially parallel light by a parabola face mirror 20 above the lamp 13 to irradiate to the irradiating chamber 12. The parabola face mirror 20 is coated with aluminum having a high reflectance for the VUV-ray (wavelength 172 nm) 14 from the lamp 13 and is further coated with magnesium fluoride (MgF₂) for preventing the reflectance from being deteriorated.

At the VUV-ray light source portion 11, the VUV-ray 14 is absorbed by oxygen molecules in air and therefore, in order to prevent the absorption, nitrogen gas is injected from a nitrogen gas injecting port 24 by a flow rate of about 25 liter/minute to bring a total of the light source portion in an atmosphere of nitrogen gas. As a result, spectral irradiance of about 50 mW/cm² is provided right under the quartz glass 19 with regard to the VUV-ray (wavelength 172 nm) 14 from the xenon excimer lamp 13. Further, numeral 34 designates a nitrogen gas exhausting port.

The irradiating chamber 12 is provided with a hydraulic pressing apparatus 21 for applying a pressure on the adhered substance from outside in order to improve adherence of the adhered substance 15. There is provided an ozone removing apparatus 22 for removing ozone since in irradiating the VUV-ray 14, oxygen in air absorbs the light and generates ozone to injure the human body.

In accordance therewith, the outside air introducing port 18 for introducing new air is provided at an upper portion of the irradiating chamber 12, and an air filter 23 for removing dust and dirt is provided on an inner side of the irradiating chamber 12 of the introducing port 18.

After ultrasonically cleaning the quartz glass 15 constituting the adhered substance for about 10 minutes and cleaning the quartz glass 15 by light for about 10 minutes by using the VUV-ray adhering apparatus 10, tetramethoxysilane (TMOS; a composition of which is TMOS monomer 91.83%, TMOS oligomer 3.32%, water/methanol 4.84%: however, composition ratios of which do not need to be strictly as they are) which is a kind of alkoxide filled in an injector is dropped on one sheet of the quartz glass 15 by pertinent spatial-intervals, other of the quartz glass 15 is overlapped on the quartz glass 15 to place on the placing apparatus 21 and is sufficiently pressed, thereafter irradiated for about 15 minutes. As a result, quartz glass plates uniformly adhered and having a sufficient adhering strength are provided.

### Example 2

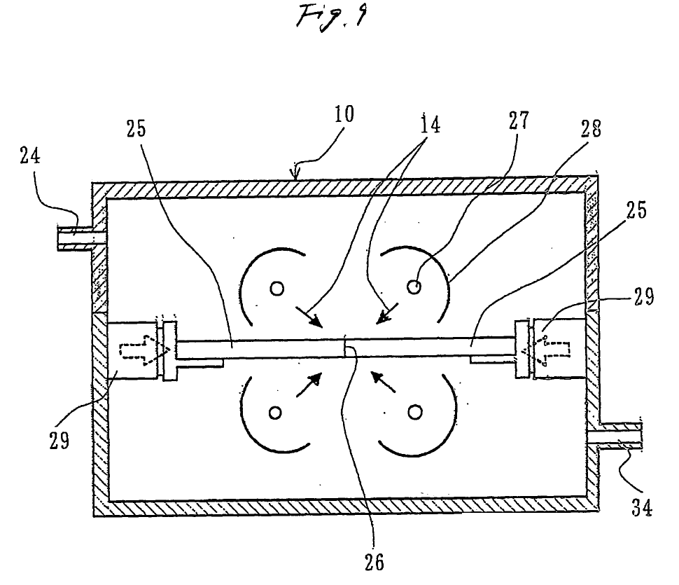

FIG. 9 shows Example 2, end faces 26 constituting adhered faces of two sheets of quartz glass 25, 25 of 50 mm×100 mm, thickness 6 mm are bonded to achieve large area formation of quartz glass.

According to the VUV-ray adhering apparatus 10, the VUV-ray light source portion 11 and the irradiating chamber 12 are not separated but integrated. Nitrogen gas is injected from the nitrogen gas injecting port 24 into the VUV-ray light source portion 11 and the irradiating chamber 12 by a flow rate of about 30 liter/minute to bring a total of inside of the chamber in an atmosphere of nitrogen gas. A low pressure mercury lamp (wavelength 185 nm) 27 is used as an irradiating light source.

An elliptical reflection mirror 28 having an elliptical shape is used for each lamp 27 and the VUV-ray is converged to the end faces 26 of the quartz glass 25, 25 constituting adhered substances. A surface of the reflection mirror 28 is worked similar to Embodiment 1.

The VUV-ray 14 from four of the low pressure mercury lamps 27 is converged to the bonding face by the elliptical reflection mirrors 28 and spectral irradiance with regard to a wavelength 185 nm at the bonding face 26 is about 100 mW/cm².

The VUV-ray adhering apparatus 10 is mounted with pressing apparatus 29, 29 capable of pressing end faces on outer sides of two sheets of the quartz glass 25, 25 from outside for applying forces from the respective end faces of the outer sides of two sheets of the quartz glass 25, 25 to press the adhered end faces 26. After subjecting the adhered end faces 26 of two sheets of the quartz glass 25, 25 to ultrasonic cleaning and light cleaning, TMOS is dropped at the adhered end faces 26, the adhered end faces 26 are brought into contact with each other by the pressing apparatus 29 and irradiated for about 15 minutes for bonding. As a result, the uniformly bonded quartz glass having a large area is provided.

### Example 3

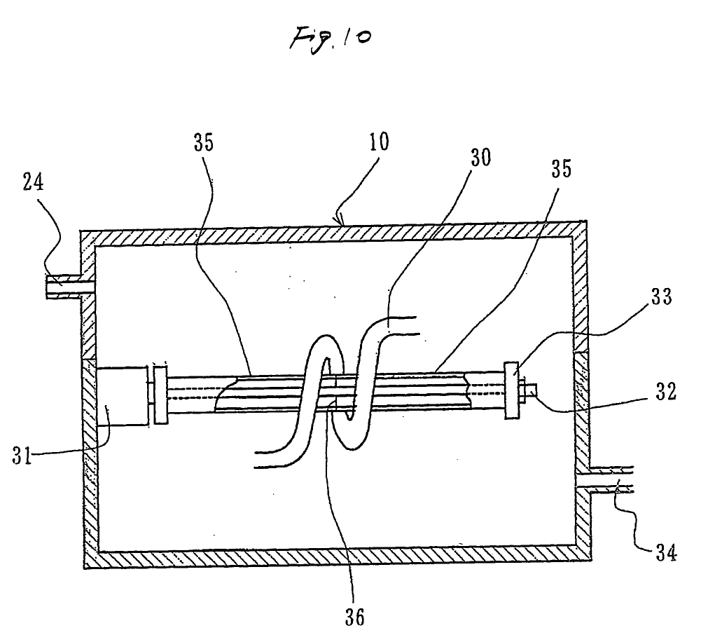

FIG. 10 shows Example 3, end faces 36 of two pieces of quartz pipes 35, 35 having a pipe diameter of 30 mm and a wall thickness of 2.5 mm are bonded to achieve prolonged formation of the quartz pipe.

In the VUV-ray adhering apparatus 10, the VUV-ray light source portion 11 and the irradiating chamber 12 are not separated but integrated. Nitrogen gas is injected from the nitrogen gas injecting port 24 into the VUV-ray light source portion 11 and the irradiating chamber 12 by a flow rate of about 30 liter/minute to bring a total of inside of the chamber in an atmosphere of nitrogen gas. As the irradiating light source, there is used a low pressure mercury lamp 30 constituted by forming a quartz glass pipe spirally as shown by the drawing. An inner diameter of the spiral of the low pressure mercury lamp 30 is about 50 mm. After subjecting the adhered end faces 36 of the quartz pipes 35, 35 to ultrasonic cleaning and light cleaning, TMOS is dropped on the adhered end faces 36 and the quartz pipes 35, 35 are attached to a rotating apparatus 31. In attaching the quartz pipes 35, 35, the quartz pipes 35, 35 are pressed by fastening a jig 33 screwed to a screw shaft 32 attached to the rotating apparatus 31. In irradiating by the low pressure mercury lamp 30, the quartz pipes 35, 35 are irradiated for about 1 hour rotating the quartz pipes 35, 35 by the rotating apparatus 31. As a result, a uniformly bonded and prolonged quartz pipe is provided.

### INDUSTRIAL APPLICABILITY

As described above, the VUV-ray adhering apparatus according to the invention is useful for adhering substances transparent for VUV-ray, particularly, quartz glass plates at room temperature.

1. A VUV-ray adhering apparatus for applying material of alkoxide to adhering faces of adhered substances and irradiating VUV-ray to the adhering faces to adhere,
the apparatus comprising:
a VUV-ray light source portion having a light source for generating the VUV-ray, and
an irradiating chamber for irradiating the VUV-ray to two of the adhered substances at least one of which is transparent for the VUV-ray.

2. The VUV-ray adhering apparatus according to claim 1, wherein
the VUV-ray light source portion and the irradiating chamber are vacuumed.

3. The VUV-ray adhering apparatus according to claim 1, wherein
the VUV-ray light source portion and the irradiating chamber are filled with nitrogen gas or rare gas.

4. The VUV-ray adhering apparatus according to claim 1, further comprising:
a partition window of a substance transparent for the VUV-ray provided between the VUV-ray light source portion and the irradiating chamber.

5. The VUV-ray adhering apparatus according to claim 4, further comprising:
an exhausting apparatus for forcibly exhausting atmosphere in the VUV-ray light source portion or the irradiating chamber.

6. The VUV-ray adhering apparatus according to any one of claim 1 through claim 5, wherein
a xenon excimer lamp or a low pressure mercury lamp is used as a light source of the VUV-ray light source portion.

7. The VUV-ray adhering apparatus according to claim 6 wherein
the light source of the VUV-ray light source portion is formed spirally.

8. The VUV-ray adhering apparatus according to claim 1, further comprising:
a light converging mirror provided at the light source of the VUV-ray light source portion.

9. The VUV-ray adhering apparatus according to claim 1, wherein further comprising:
a light converging mirror provided at the light source of the VUV-ray light source portion.

10. The VUV-ray adhering apparatus according to claim 1,
wherein
an inner wall face of the VUV-ray light source portion or the irradiating chamber is constituted by a material of aluminum.

11. The VUV-ray adhering apparatus according to claim 1, wherein
an inner wall face of the VUV-ray light source portion or the irradiating chamber is constituted by a material of aluminum.

12. The VUV-ray adhering apparatus according to claim 1,
wherein
an inner wall face of the VUV-ray light source portion or the irradiating chamber is constituted by a material of aluminum.

13. The VUV-ray adhering apparatus according to claim 1, further comprising:
a pressing apparatus for pressing adhering faces of two of the adhered substances.

14. The VUV-ray adhering apparatus according to claim 10, further comprising:
a pressing apparatus for pressing adhering faces of two of the adhered substances.

15. The VUV-ray adhering apparatus according to claim 11, further comprising:
a pressing apparatus for pressing adhering faces of two of the adhered substances.

16. The VUV-ray adhering apparatus according to claim 12, further comprising:
a pressing apparatus for pressing adhering faces of two of the adhered substances.

17. The VUV-ray adhering apparatus according to claim 6, wherein a supporting member for supporting the adhered substance is made to be rotatable.

18. The VUV-ray adhering apparatus according to claim 13, wherein a supporting member for supporting the adhered substance is made to be rotatable.

19. The VUV-ray adhering apparatus according to claim 14, wherein a supporting member for supporting the adhered substance is made to be rotatable.

20. The VUV-ray adhering apparatus according to claim 15, wherein a supporting member for supporting the adhered substance is made to be rotatable.

21. The VUV-ray adhering apparatus according to claim 16, wherein a supporting member for supporting the adhered substance is made to be rotatable.
